(19) United States
(12) Patent Application Publication
(10) Pub. No.: US 2023/0324520 A1
(43) Pub. Date: Oct. 12, 2023

(54) LIGHT SOURCE DEVICE AND DISTANCE MEASUREMENT DEVICE

(71) Applicant: HAMAMATSU PHOTONICS K.K., Hamamatsu-shi (JP)

(72) Inventors: Tomonori NAKAMURA, Hamamatsu-shi (JP); Kenichiro IKEMURA, Hamamatsu-shi (JP)

(73) Assignee: HAMAMATSU PHOTONICS K.K., Hamamatsu-shi (JP)

(21) Appl. No.: 18/104,340

(22) Filed: Feb. 1, 2023

(30) Foreign Application Priority Data
Apr. 7, 2022 (JP) 2022-064015

(51) Int. Cl. G01S 7/481; G01S 17/34

(52) U.S. Cl. CPC G01S 7/4817; G01S 17/34

(57) ABSTRACT

A light source device includes a light source that generates continuous light, a retroreflective material that retroreflects a light beam from the light source, an optical system that guides the light beam from the light source to the retroreflective material and output the light beam retroreflected from the retroreflective material to the outside, and a modulation unit that is disposed in the optical system, changes an optical path length between the light source and the retroreflective material with time, and changes a wavelength of the light beam with time using a Doppler effect.

### TECHNICAL FIELD

The present disclosure relates to a light source device and a distance measurement device.

### BACKGROUND

In the related art, examples of a distance measurement device using light include a distance measurement device described in International Publication No. 2019/116980. This distance measurement device of the related art is a device that performs distance measurement using a plurality of distance measurement signals, and performs quadrature modulation or the like on an optical carrier wave to generate transmission light. The distance measurement device receives reflected light obtained by the transmission light being reflected by a measurement target object, and calculates a distance to the target object on the basis of a plurality of signals obtained by performing orthogonal demodulation or the like on the reflected light.

### SUMMARY

As a distance measurement scheme using light, for example, a frequency modulated continuous wave (FMCW) scheme is known. In the FMCW scheme, a target object is irradiated with measurement light modulated so that a frequency of the measurement light is linearly shifted with respect to time. and Fourier transform is performed on a signal on the basis of interference light between the measurement light and reflected light, such that a distance to the target object or the like can be calculated.

Examples of a method of modulating a frequency of measurement light may include a method using a wavelength swept light source that changes a wavelength of light with time (for example, see “200 kHz High-speed Wavelength Swept Light Source using KTN Crystal and SS-OCT System” by Junya Kobayashi et al. NTT Technical Journal, February, 2014), and a method of scanning with a frequency of sidebands generated using a phase modulator or an intensity modulator. However, in the FMCW scheme, an extremely narrow wavelength width is required for measurement light, and a sufficient intensity is also required to secure a measurement distance. Therefore, it is desired to develop a light source device capable of obtaining sufficient frequency shift without affecting the quality of a light source such as a wavelength width or an intensity waveform.

The present disclosure has been made to solve the above problem, and an object of the present disclosure is to provide a light source device capable of obtaining sufficient frequency shift without affecting the quality of a light source, and a distance measurement device using the same.

A light source device according to an aspect of the present disclosure includes a light source device including: a light source configured to generate continuous light; a retroreflective material configured to retroreflect the light from the light source; an optical system configured to guide the light from the light source to the retroreflective material and output the light retroreflected from the retroreflective material to the outside; and a modulation unit configured to be disposed in the optical system, change an optical path length between the light source and the retroreflective material with time, and change a wavelength of the light with time using a Doppler effect.

In this light source device, the optical path length between the laser light source and the retroreflective material is changed with time, thereby changing the wavelength of the light with time using the Doppler effect. It is possible to obtain sufficient frequency shift without affecting the quality of a light source such as a wavelength width or an intensity waveform, by adopting such a light modulation scheme.

The modulation unit may be configured of a scanning unit configured to change a position of irradiation of the light on the retroreflective material, with time. In this case, it is possible to change the optical path length between the light source and the retroreflective material with time with a simple configuration. Further, it is possible to easily secure the linearity of the frequency shift through adjustment of a scanning speed in the scanning unit.

The modulation unit may be configured of a rotation body configured to rotate the retroreflective material to change a position of irradiation of the light on the retroreflective material, with time. In this case, it is possible to change the optical path length between the light source and the retroreflective material with time with a simple configuration. Further, it is possible to easily secure the linearity of the frequency shift through adjustment of a rotational speed in the rotation body.

The rotation body may have an outer surface and an inner surface, and the retroreflective material may be provided on the outer surface of the rotation body. In this case, it is possible to change the optical path length between the light source and the retroreflective material with time with a simple configuration. Further, it is possible to easily adjust a surface shape of the retroreflective material through adjustment of a shape of the outer surface of the rotation body.

The rotation body may have an outer surface and an inner surface, and the retroreflective material may be provided on the inner surface of the rotation body. In this case, it is possible to change the optical path length between the light source and the retroreflective material with time with a simple configuration. Further, it is possible to easily adjust the surface shape of the retroreflective material through the adjustment of the shape of the outer surface of the rotation body.

A surface on which the retroreflective material is disposed in the rotation body may have a curved surface shape such that the wavelength of the light linearly changes with time due to rotation of the rotation body. In this case, it is possible to easily secure the linearity of the frequency shift while keeping the rotational speed of the rotation body constant.

A distance measurement device according to an aspect of the present disclosure includes the light source device; a splitting unit configured to divide the light output from the light source device into measurement light and reference light; an irradiation unit configured to irradiate a target object with the measurement light; a detection unit configured to detect interference light between reflected light obtained by the measurement light being reflected by the target object and the reference light; and a calculation unit configured to calculate a distance to the target object on the basis of an output signal from the detection unit.

With this distance measurement device, it is possible to obtain sufficient frequency shift in the measurement light without affecting the quality of a light source such as a wavelength width or an intensity waveform, by adopting a light modulation scheme.

### BRIEF DESCRIPTION OF THE DRAWINGS

FIG. 1 is a block diagram illustrating a configuration of a distance measurement device according to an embodiment of the present disclosure;

FIG. 2A is a diagram illustrating an example of a waveform of a signal that is generated by a signal generation unit.

FIG. 2B is a diagram illustrating a waveform of light modulated by the signal illustrated in FIG. 2A.

FIG. 3 is a diagram illustrating an example of a waveform of interference light between reflected light and reference light.

FIG. 4 is a diagram illustrating a relationship between a difference frequency and an intensity of interference light.

FIG. 5 is a block diagram illustrating a configuration of a light source device.

FIG. 6 is a schematic diagram illustrating a configuration of a retroreflective material.

FIG. 7 is a schematic diagram illustrating a modulation unit according to a modification example.

FIG. 8 is a diagram illustrating an example of a curved shape of an outer surface of a polygon mirror.

FIG. 9 is an enlarged view of a main portion in FIG. 7.

FIG. 10 is an enlarged view of a main portion illustrating another example of the curved surface shape of the outer surface of the polygon mirror.

FIG. 11 is an enlarged view of a main portion illustrating still another example of the curved surface shape of the outer surface of the polygon mirror.

FIG. 12A is a schematic perspective view illustrating modulation according to another modification example.

FIG. 12B is a front view of FIG. 12A.

### DETAILED DESCRIPTION

Hereinafter, preferred embodiments of a light source device and a distance measurement device according to an aspect of the present disclosure will be described in detail with reference to the drawings.

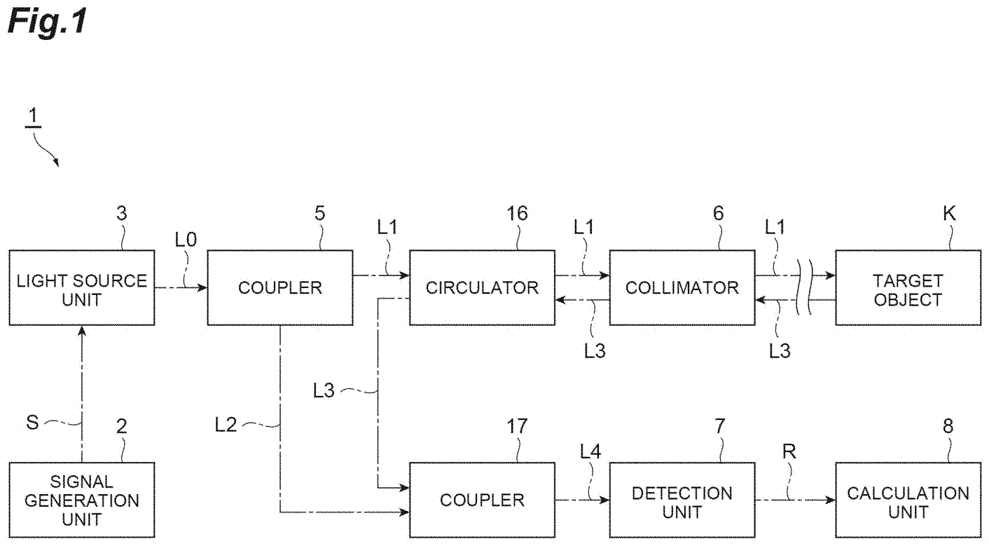

FIG. 1 is a block diagram illustrating a configuration of a distance measurement device according to an embodiment of the present disclosure. A distance measurement device 1 illustrated in FIG. 1 is configured as a device that measures a distance to a target object K on the basis of a frequency modulated continuous wave (FMCW) scheme. The distance measurement device 1 irradiates a target object K with measurement light L1 modulated such that a frequency is linearly shifted with respect to time, and performs Fourier-transform on a signal on the basis of interference light L4 between reference light L2 and reflected light L3 to calculate a distance to the target object K.

As illustrated in FIG. 1, the distance measurement device 1 includes a signal generation unit 2, a light source unit 3, a coupler (splitting unit) 5, a collimator (irradiation unit) 6, a detection unit 7, and a calculation unit 8. Optical components from the light source unit 3 to the detection unit 7 are optically connected by, for example, an optical fiber.

The signal generation unit 2 is a portion that generates a signal used for modulation of the measurement light L1. The signal generation unit 2 is configured of, for example, an analog waveform shaper. A signal S generated by the signal generation unit 2 is input to the light source unit 3. The light source unit 3 is configured of a light source device 21 according to an embodiment of the present disclosure. Details of the light source device 21 will be described below. The light source unit 3 generates a light beam L0 whose wavelength is modulated with time through modulation based on the signal S generated by the signal generation unit 2. The light beam L0 generated by the light source unit 3 is input to the coupler 5.

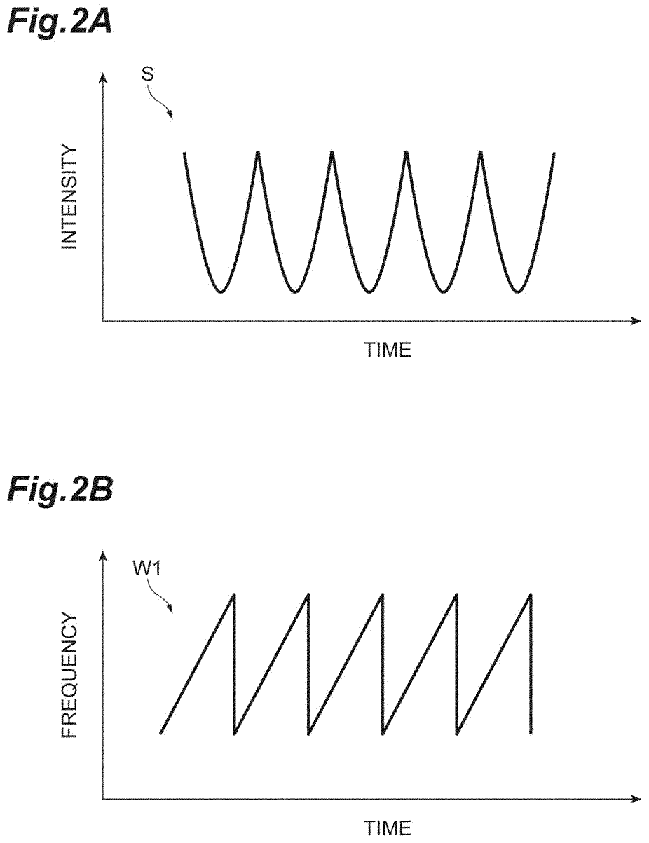

FIG. 2A is a diagram illustrating an example of a waveform of the signal generated by the signal generation unit, and FIG. 2B is a diagram illustrating a waveform of light modulated by the signal illustrated in FIG. 2A. As illustrated in FIG. 2A, in the present embodiment, the signal generation unit 2 generates a signal S having a temporal waveform having continuous parabolas with a positive proportionality constant. Accordingly, a modulated waveform W1 of the light beam L0 output from the light source unit 3 becomes a temporal triangular waveform, as illustrated in FIG. 2B. More specifically, the modulated waveform W1 of the light beam L0 becomes a sawtooth waveform, and a portion in which the frequency increases linearly with time and a portion in which the frequency instantaneously decreases are formed in each period.

The coupler 5 is a portion that splits the light beam L0 output from the light source unit 3 into the measurement light L1 and the reference light L2. Both the measurement light L1 and the reference light L2 have sawtooth waveforms illustrated in FIG. 2B. The measurement light L1 output from the coupler 5 is input to an input port of a three-port type of circulator 16.

The measurement light L1 is output from an input and output port of the circulator 16, and the target object K outside the distance measurement device 1 is irradiated with the measurement light L1 via a collimator 6. The reflected light L3 obtained by the measurement light L1 being reflected by the target object K is returned to the distance measurement device 1, and is input to a coupler 17 at a stage after the coupler 5 from the input and output port of the circulator 16 via an output port thereof. The reference light L2 output from the coupler 5 is directly input to the coupler 17 at the subsequent stage. In the coupler 17 at the subsequent stage, the interference light L4 is generated by interference between the reflected light L3 and the reference light L2. The interference light L4 is input to the detection unit 7.

The detection unit 7 is a portion that detects the interference light L4 between the reflected light L3 and the reference light L2. The detection unit 7 is configured of, for example, a balance detector. The balanced detector is a detector that receives two optical inputs and detects a difference between photocurrents thereof. The detection unit 7 outputs an output signal R indicating a detection result to the calculation unit 8.

The calculation unit 8 calculates the distance to the target object K on the basis of the output signal from the detection unit 7. The calculation unit 8 is physically configured of a computer system including, for example, a processor and a memory. Examples of the computer system may include a personal computer, a microcomputer, a cloud server, and a smart device (a smartphone, a tablet terminal, or the like). The calculation unit 8 may be configured of a programmable logic device (PLD), or may be configured of an integrated circuit such as a field-programmable gate array (FPGA).

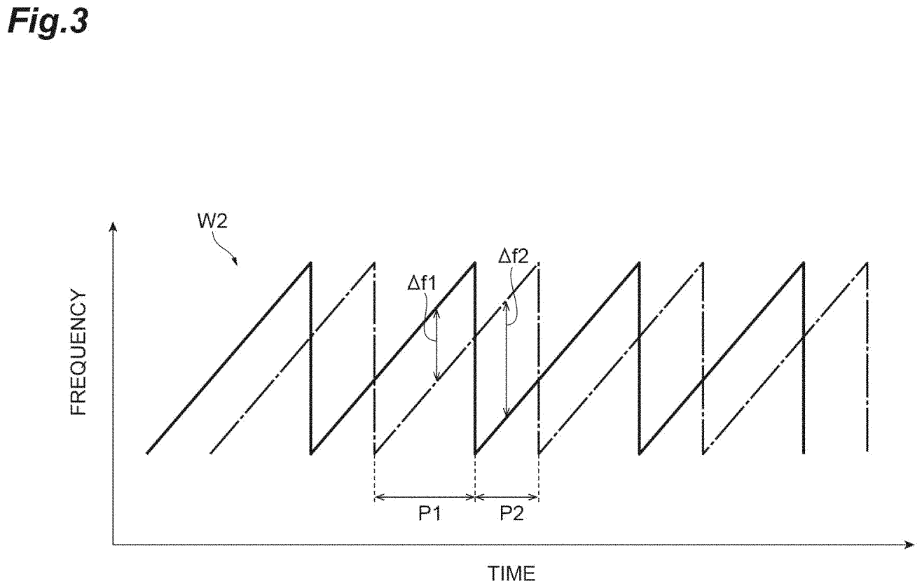

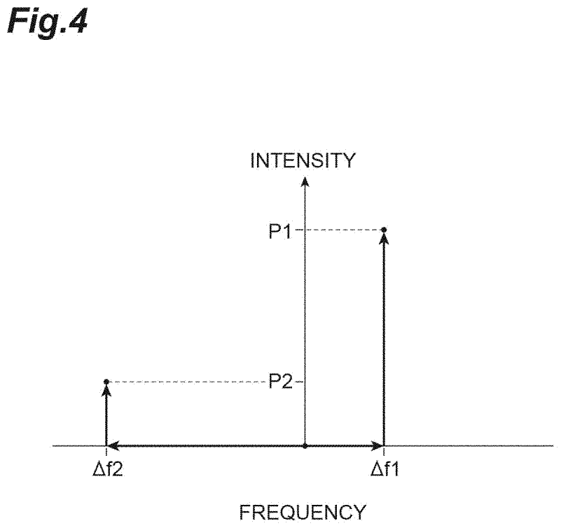

FIG. 3 is a diagram illustrating an example of a waveform of the interference light between the reflected light and the reference light. In the temporal waveform W2 of the interference light L4 illustrated in FIG. 3, since the reflected light L3 is light returned by the measurement light L1 being reflected by the target object K, the reflected light L3 is delayed with time with respect to the reference light L2 depending on the distance to the target object K. When the reflected light L3 is delayed with respect to the reference light L2, a frequency difference occurs between the reference light L2 and the reflected light L3.

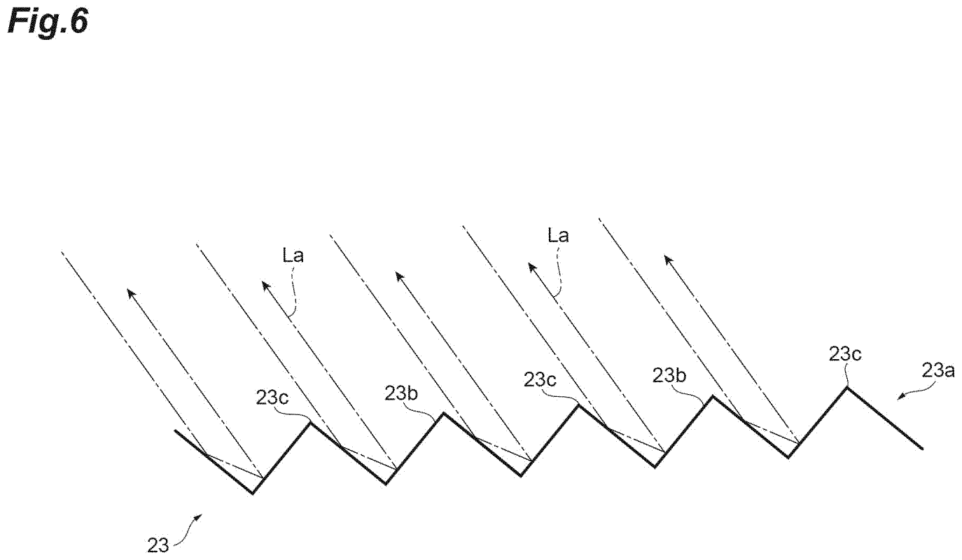

The calculation unit 8 calculates a first difference frequency Δf1 of the reflected light L3 with respect to the reference light L2 and a second difference frequency Δf2 of the reference light L2 with respect to the reflected light L3. The calculation unit 8 calculates the distance to the target object K on the basis of the first difference frequency Δf1 and a first intensity P1 of the interference light L4 with respect to the first difference frequency Δf1, and the second difference frequency Δf2 and a second intensity P2 of the interference light L4 with respect to the second difference frequency Δf2. A relationship between the first differential frequency Δf1 and the first intensity P1 and a relationship between the second differential frequency Δf2 and the second intensity P2 can be obtained by Fourier transform of an output signal R of the interference light L4, as illustrated in FIG. 6.

When a chirp width of the measurement light L1 and the reference light L2 is B and a repetition frequency is F, a chirp speed of the measurement light L1 and the reference light L2 is expressed by B×F. When the distance to the target object K is X, X can be calculated by Equation (1) below. In Equation (1), c is a speed of light.

X=(c/(2F))×{(P1×Δf1+P2×Δf2)/(P1+P2)}/B (1)

Next, the light source device 21 described above will be described in detail.

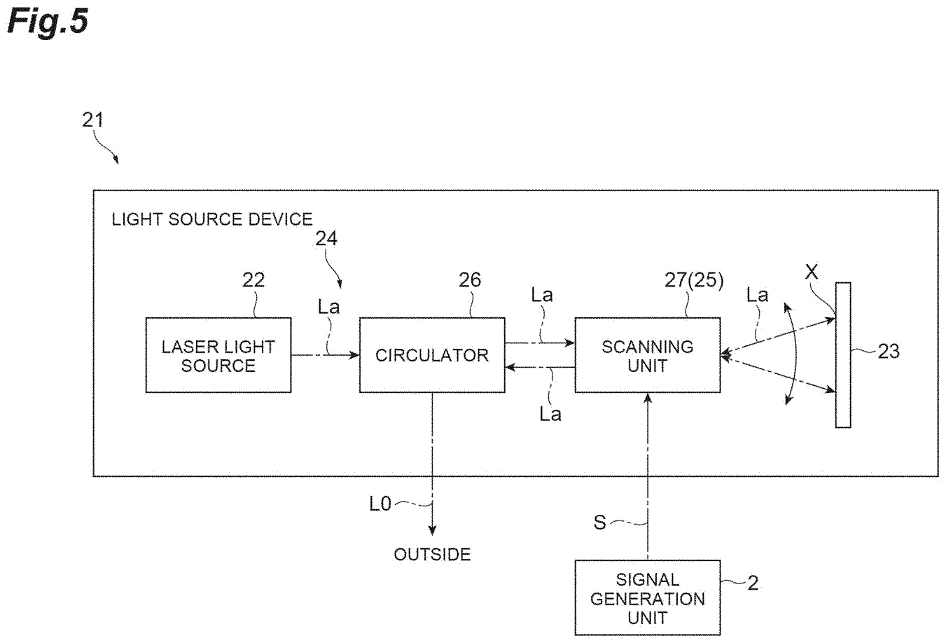

FIG. 5 is a block diagram illustrating a configuration of the light source device. As illustrated in FIG. 5, the light source device 21 includes a laser light source (light source) 22, a retroreflective material 23, an optical system 24 and a modulation unit 25. As the laser light source 22, for example, a stable light source such as a laser diode (LD) may be used. The laser light source 22 generates and outputs a continuous light beam La such as continuous wave (CW) light.

The retroreflective material 23 is a member that retroreflects the light beam La from the laser light source 22. The retroreflective material 23 reflects the incident light beam La in an incidence direction, as illustrated in FIG. 6. The retroreflective material 23 is configured of a reflective surface having a minute corner cube formed thereon, microbeads, or the like. In the example of FIG. 6, a groove portion 23b having a triangular cross-sectional shape is formed on a reflective surface 23a of the retroreflective material 23. It is possible to set an angle θ of a top portion 23c between the groove portions 23b and 23b to 90° when a scanning direction of the light beam La in a scanning unit 27 to be described below is uniaxial.

The optical system 24 is a light guide system that guides the light beam La from the laser light source 22 to the retroreflective material 23 and outputs light retroreflected from the retroreflective material 23 to the outside. A circulator 26 and the scanning unit 27 are disposed in the optical system 24, as illustrated in FIG. 5. At least the laser light source 22 and the circulator 26 may be optically connected by an optical fiber. The light beam La from the laser light source 22 is input to an input port of the circulator 26 and output to the scanning unit 27 from the input and output port.

The scanning unit 27 is an aspect of the modulation unit 25 in the present disclosure. The scanning unit 27 changes an optical path length between the laser light source 22 and the retroreflective material 23 with time, and changes a wavelength of the light beam La with time using a Doppler effect. Specifically, the scanning unit 27 is configured of, for example, an electro-optic crystal such as a KTN crystal, a Galvano mirror, a MEMS mirror, or a polygon mirror.

The scanning unit 27 changes an angle of incidence of the light beam La on the retroreflective material 23 on the basis of the signal S input from the signal generation unit 2, and changes an irradiation position X of the light beam La with time in a direction orthogonal to a direction in which the groove portion 23b in the retroreflective material 23 extends. The change in the optical path length between the laser light source 22 and the retroreflective material 23 with time through scanning of the light beam La in the scanning unit 27 can result in the Doppler effect for the light beam La. The light beam La modulated by the scanning unit 27 corresponds to the light beam L0 described above. The light beam L0 is output to the outside (here, the coupler 5 of the distance measurement device 1) from the input and output port of the circulator 16 through the output port.

For example, when the wavelength of the light beam La is 1.5 μm, the optical path length is changed by 15 mm in 1/1000 of a second, resulting in a change in optical path length corresponding to 10 million wavelengths per second. In this case, the wavelength of the light beam La changes by 10 MHz on average due to the Doppler effect. It is possible to linearly change the wavelength of the light beam La by controlling a speed of a temporal change in the optical path length using the signal S.

As described above, in the light source device 21, the optical path length between the laser light source 22 and the retroreflective material 23 is changed with time, thereby changing the wavelength of the light beam La with time using the Doppler effect. By adopting a light modulation scheme using such a retroreflective material 23, it is possible to obtain a sufficient frequency shift without affecting the quality of the laser light source 22 such as a wavelength width or intensity waveform.

As a comparative example, when a light source device in which an electro-optic (EO) phase modulator is disposed outside a laser resonator is assumed, a change in an optical path length of a resonator is about one wavelength of the light generated from the laser light source. A shift amount of a frequency in a modulated waveform of the measurement light output from the light source device is estimated to be about eight times the repetition frequency. On the other hand, in the light source device 21 using the retroreflective material 23, a change in the optical path length of the light beam La can be increased to about tens of thousands of times the wavelength of the light beam La. A shift amount of a frequency in the modulated waveform W1 of the measurement light L1 output from the light source device 21 can be increased up to about 8×tens of thousands of times the repetition frequency.

In the light source device 21, the modulation unit 25 is configured of the scanning unit 27 that changes, with time, the position X of irradiation of the light beam La on the retroreflective material 23. This makes it possible to change the optical path length between the laser light source 22 and the retroreflective material 23 with time with a simple configuration. Further, it is possible to easily secure the linearity of the frequency shift through adjustment of the scanning speed in the scanning unit 27.

In the distance measurement device 1 using the light source device 21, it is possible to obtain sufficient frequency shift in the measurement light without affecting the quality of a light source such as a wavelength width or an intensity waveform by adopting a light modulation scheme using the retroreflective material 23. Therefore, a position of the target object K can be calculated with high resolution.

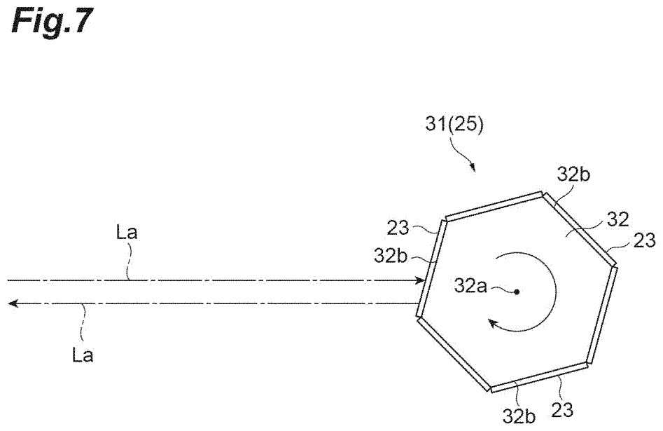

The present disclosure is not limited to the above embodiments. For example, although the modulation unit 25 is configured of the scanning unit 27 that changes, with time, the position X of irradiation of the light beam La on the retroreflective material 23 in the embodiment, various modifications can be applied to the configuration of the modulation unit 25. For example, the modulation unit 25 may be configured of a rotation body 31 that rotates the retroreflective material 23 to change, with time, the position X of irradiation of the light beam La on the retroreflective material 23, as illustrated in FIG. 7. Also in such a configuration, it is possible to change the optical path length between the laser light source 22 and the retroreflective material 23 with time with a simple configuration. Further, it is possible to easily secure the linearity of the frequency shift through adjustment of the rotational speed in the rotation body 31.

In the example of FIG. 7, the rotation body 31 is configured of a polygon mirror 32. The polygon mirror 32 has a plurality of outer surfaces 32b that rotate around a central axis 32a, and the retroreflective material 23 is provided on each outer surface 32b. Although it is possible to linearly shift a frequency of the light beam La through adjustment of a rotational speed of the polygon mirror 32, it is also possible to secure linearity of frequency shift of the light beam La while keeping the rotational speed constant by adjusting a shape of the outer surface 32b. Further, it is possible to easily adjust a surface shape of the retroreflective material 23 by adjusting the shape of the outer surface 32b of the polygon mirror 32.

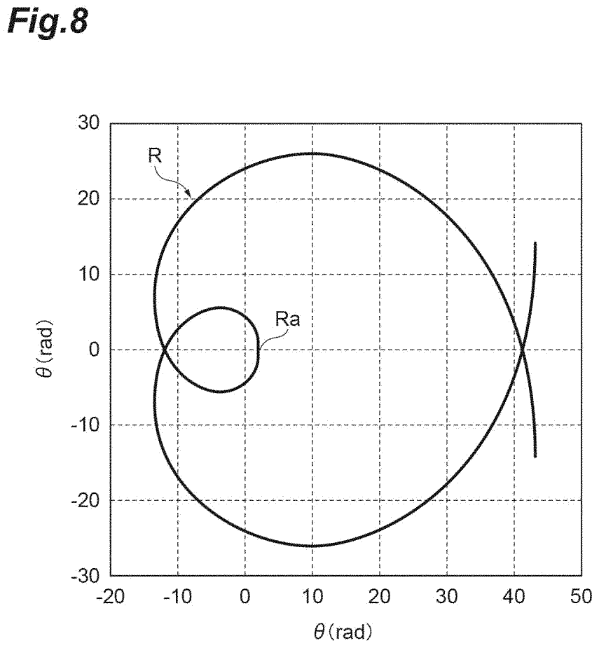

Specifically, when a rotational speed of the polygon mirror 32 is constant, a distance between the laser light source 22 and the polygon mirror 32 is DO, and a rotation angle of the polygon mirror 32 in a polar coordinate system with an emission position of the light beam La as an origin is 0, a curved surface shape R of the outer surface 32b of the polygon mirror 32 is a portion of a spiral shape expressed by Equation (2) below, as illustrated in FIG. 8. In Equation (2), a is a proportionality constant.

R=aθ²+D0 (2)

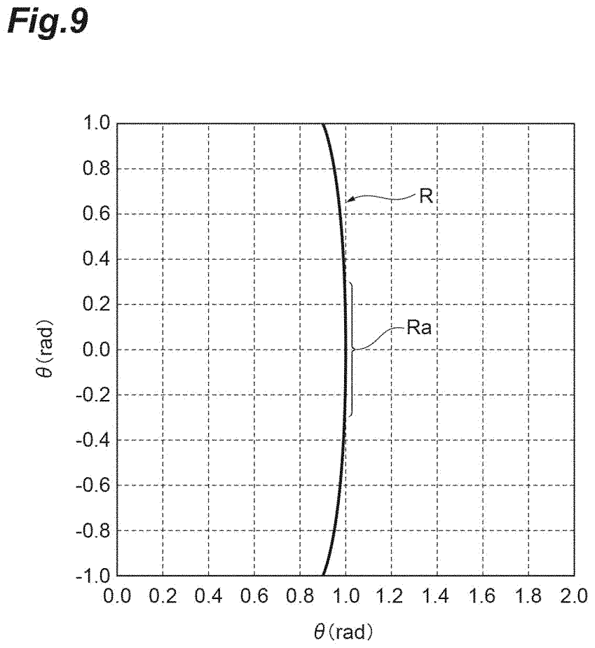

When a unit of θ in the Equation (2) is radians, and a=D0/2, a substantially flat surface Ra can be formed in the curved surface shape R, as illustrated in FIG. 9. Therefore, the surface Ra is set as a use surface (attachment range) of the retroreflective material 23 on the outer surface 32b of the polygon mirror 32, making it possible to avoid complication of the shape of the outer surface 32b in securing the linearity of the frequency shift of the light beam La even when the rotational speed of the polygon mirror 32 is constant.

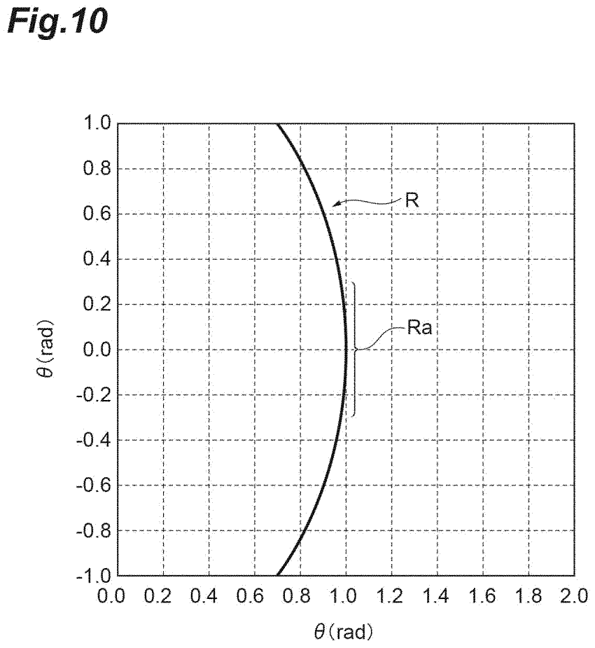

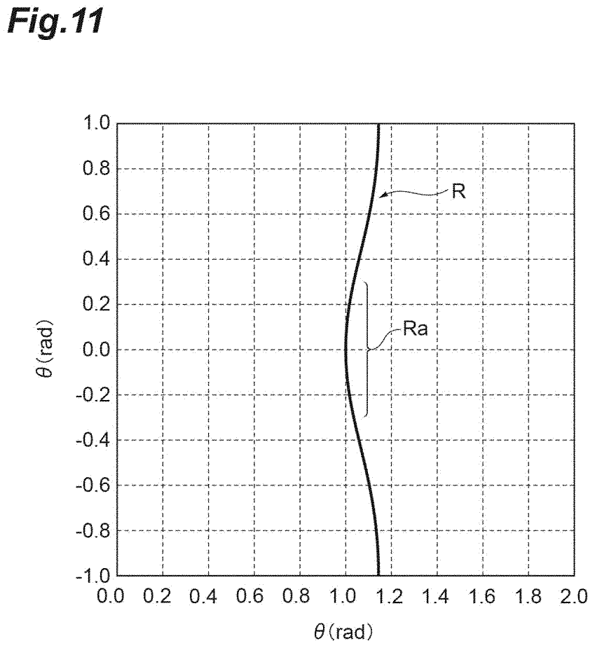

A relatively flat surface Ra can be formed in a curved surface shape R when a=D0/4 (see FIG. 10) and when a=D0 (see FIG. 11) as well. As in the case of FIG. 9, the surface Ra is set as the use surface (attachment range) of the retroreflective material 23 on the outer surface 32b of the polygon mirror 32, making it possible to avoid the complication of the shape of the outer surface 32b in securing the linearity of the frequency shift of the light beam La even when the rotational speed of the polygon mirror 32 is constant.

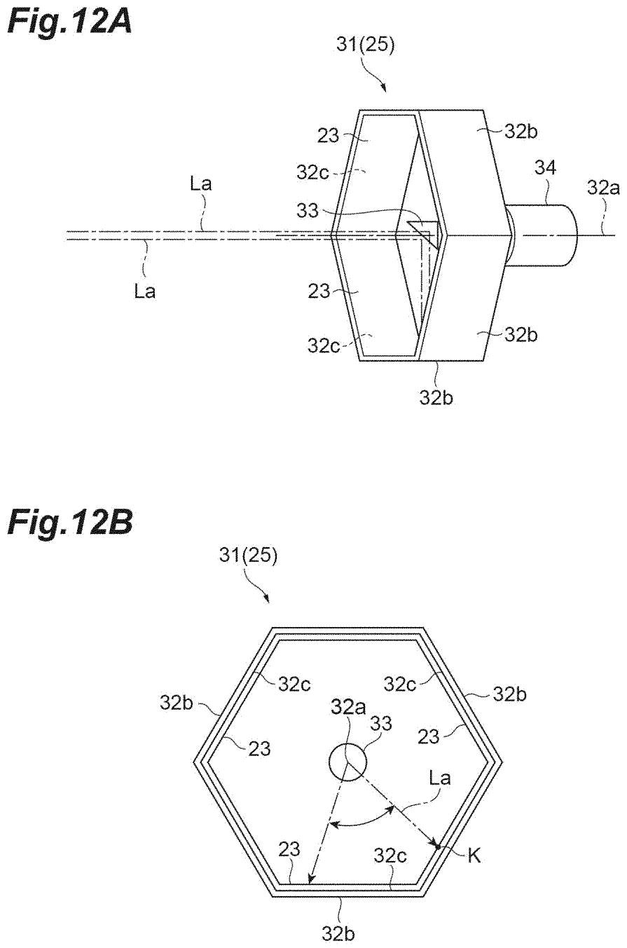

As illustrated in FIG. 12A, a configuration in which the retroreflective material 23 is provided on a plurality of inner surfaces 32c of the polygon mirror 32 may be adopted. The inner surface 32c is a surface located on a side opposite to the outer surface 32b. In the example of FIG. 12A, for example, a beveled cylindrical rotation mirror 33 is disposed on the central axis 32a of the polygon mirror 32. The rotation mirror 33 is rotatable around the central axis 32a by a motor 34.

In such a configuration, it is possible to change, with time, the position X of irradiation of the light beam La on the retroreflective material 23, as illustrated in FIG. 12B, by the rotation mirror 33 rotating with respect to the polygon mirror 32. Therefore, it is possible to change the optical path length between the laser light source 22 and the retroreflective material 23 with time with a simple configuration. A shape of the inner surface 32c may be the same curved surface shape R as that of the outer surface 32b. In this case, even when the rotational speed of the polygon mirror 32 is made constant, it is possible to avoid the complication of the shape of the inner surface 32c in securing the linearity of the frequency shift of the light beam La.

What is claimed is:

1. A light source device comprising:
a light source configured to generate continuous light;
a retroreflective material configured to retroreflect the light from the light source;
an optical system configured to guide the light from the light source to the retroreflective material and output the light retroreflected from the retroreflective material to the outside; and
a modulator configured to be disposed in the optical system, change an optical path length between the light source and the retroreflective material with time, and change a wavelength of the light with time using a Doppler effect.

2. The light source device according to claim 1, wherein the modulator is configured of a scanner configured to change a position of irradiation of the light on the retroreflective material with time.

3. The light source device according to claim 1, wherein the modulator is configured of a rotation body configured to rotate the retroreflective material to change a position of irradiation of the light on the retroreflective material with time.

4. The light source device according to claim 3,
wherein the rotation body has an outer surface and an inner surface, and
the retroreflective material is provided on the outer surface of the rotation body.

5. The light source device according to claim 3,
wherein the rotation body has an outer surface and an inner surface, and
the retroreflective material is provided on the inner surface of the rotation body.

6. The light source device according to claim 3, wherein a surface on which the retroreflective material is disposed in the rotation body has a curved surface shape such that the wavelength of the light linearly changes with time due to rotation of the rotation body.

7. A distance measurement device comprising:
the light source device according to claim 1;
a splitter configured to divide the light output from the light source device into measurement light and reference light;
an irradiator configured to irradiate a target object with the measurement light;
a detector configured to detect interference light between reflected light obtained by the measurement light being reflected by the target object and the reference light; and
a calculator configured to calculate a distance to the target object on the basis of an output signal from the detector.
